(19) United States
(12) Patent Application Publication
(10) Pub. No.: US 2002/0085569 A1
(43) Pub. Date: Jul. 4, 2002

(54) Communication control apparatus and method, and communication system using the communication control apparatus

(76) Inventor: Rumiko Inoue, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/033,031

(22) Filed: Dec. 27, 2001

(30) Foreign Application Priority Data
Dec. 28, 2000 (JP) 2000-402066

(51) Int. Cl. H04L 12/56

(52) U.S. Cl. 370/401; 370/230

(57) ABSTRACT

In a communication control apparatus and method of the present invention, a current state of communications in a predetermined route on an IP network is detected. In response to a request for connecting a new call to the predetermined route, it is determined whether the request is accepted or rejected, based on a result of comparison of the detected state of communications in the predetermined route and a maximum amount of traffic of packets permitted for the predetermined route.

### BACKGROUND OF THE INVENTION

1. Field of the Invention

The present invention relates to a communication control apparatus and method, and a communication system using the communication control apparatus. More specifically, the present invention relates to a communication control apparatus and method which controls voice and data transmission over a packet network using the VoIP, and relates to a communication system using the communication control apparatus.

2. Description of the Related Art

Recently, with the spread of the Internet or corporate Intranets on a worldwide basis, packet-based networks using the IP (Internet Protocol) are increasingly expanded. The VoIP (Voice over Internet Protocol) technology is known as the technology used to transmit voice conversations over a data network using the Internet Protocol. Such data network may be the Internet or a corporate Intranet. The use of the VoIP technology will achieve the benefits of managing a voice and data network as one network, and provide efficient utilization of channels in the network.

The standard H. 323 by the International Telecommunications Union (ITU-T) provides a set of standards defining real-time multimedia communications for packet-based networks (which are called IP telephony). The standard H. 323 defines a set of call control, channel setup and codec specifications for transmitting real-time voice and video over networks, such as packet networks, and in particular the Internet, LANs, WANs and Intranets.

FIG. 1 shows a conventional communication system using the VoIP technology.

As shown in FIG. 1, the communication system includes two IP networks: a LAN (local area network) 10 and a LAN 11. In the LAN 10, a gateway 12, a gateway 13 a router 14 and a gatekeeper 15 are connected together. In the LAN 11, a gateway 16, a gateway 17 and a router 18 are connected together. The router 14 and the router 18 are linked to each other by a WAN (wide area network) 19.

In the communication system in FIG. 1, the gateways 12 and 13 on the LAN 10 and the gateways 16 and 17 on the LAN 11 are one of the four major components defined by the standard H.323: terminals, gateways, gatekeepers and multipoint control units. The gateways 12, 13, 16 and 17 are IPT (Internet Protocol Telephony) gateways that bridge H.323 conferences to other networks, communication protocols and multimedia formats. The gateways 12, 13, 16 and 17 perform processes needed to transmit voice conversations over the LAN or WAN using the Internet Protocol. Hereinafter, for the sake of convenience, the gateway 12 and the gateway 13 are indicated by “GATEWAY #1” and “GATEWAY #2”, respectively, and the gateway 16 and the gateway 17 are indicated by “GATEWAY #3” and “GATEWAY #4”, respectively, in FIG. 1.

In the communication system in FIG. 1, the gatekeeper 15 is one of the four major components defined by the standard H.323. The gatekeeper 15 performs two important functions which help maintain the robustness of the network-address translation and bandwidth management. The gatekeeper 15 maps phone numbers of respective terminals (e.g., telephones) on the LAN 10 into IP addresses on the WAN 19 and provides address lookups when needed. The gatekeeper 15 also exercises call control functions to limit the number of H.323 connections, and the total bandwidth used by these connections, in an H.323 zone.

Generally, when the VoIP environment is constructed on the IP-based network, the router performs the routing operations of voice packets by using the IP in the same manner as the routing operations of data packets. When the amount of the traffic of voice packets exceeds the bandwidth of the transmitting route, some of the voice packets may be abandoned at the router. If the voice packets are abandoned too much, the quality of the voice signal will deteriorate and the conversation over the network will not be possible. Therefore, it is necessary that the amount of the traffic of voice packets be controlled such that it does not exceed the bandwidth of the transmitting route. To achieve this, a maximum number of connections permitted for each gateway is predetermined and stored into the gatekeeper 15 for comparison of the number of connections related to the gateway of concern with the same. If the number of connections related to the gateway of concern is larger than the maximum number, the establishment of a new connection related to the gateway of concern is inhibited such that the amount of the traffic on the network does not exceed the bandwidth of the transmitting route.

In the communication system in FIG. 1, the gatekeeper 15 performs the above-mentioned call control function. Suppose that the WAN 19 has a restriction that the maximum number of connections in the route between the router 14 and router 18 is four. The gatekeeper 15 functions to limit the number of current connections in the network, served by the gatekeeper 15, such that the number of current connections related to the gatekeeper 15 does not exceed the maximum number.

For example, when the telephone (not shown) on the gateway 12 sends a new call to the telephone (not shown) on the gateway 13, the gateway 12 at that time transmits an inquiry to the gatekeeper 15. In response to the inquiry, the gatekeeper 15 determines whether the number of current connections when the newly requested connection is added thereto exceeds a maximum number of connections allocated to the gateway 12. When it is determined that the maximum number is not exceeded, the gatekeeper 15 returns a call setup reply (acceptance) to the gateway 12 and sends an IP address, corresponding to the phone number of the called telephone, to the gateway 12. In such a case, the communication path (channel) between the gateway 12 and the gateway 13 is established under the control of the router 14. The gateway 13 can deliver the call, received from the calling telephone on the gateway 12 via the communication path, to the destination telephone on the gateway 13. In this manner, the gatekeeper 15 functions to limit the number of connections in the network such that it does not exceed the maximum number of connections permitted for the gateway of concern.

However, the communication system in FIG. 1 has the following problems. Suppose that there are currently four connections on the route between the gateway 12 and the gateway 13 (indicated by the arrow in FIG. 1) the number of which is equal to a maximum number of connections permitted for the gateway 12, but the network 19 between the router 14 and the router 18 still has the bandwidth adequate for including an additional connection. In this condition, when the telephone (not shown) on the gateway 12 is about to send a new call to the telephone (not shown) on the gateway 13 (which is the fifth connection), the gateway 12 at that time transmits an inquiry to the gatekeeper 15. In response to the inquiry, the gatekeeper 15 determines that the number of current connections in the network, including the fifth connection, exceeds the maximum number of connections permitted for the gateway 12. Hence, the gatekeeper 15 returns a call setup reply (rejection) to the gateway 12. When making this determination in this case, the gatekeeper 15 does not take into account the state of the communications on the network 19. Even when the non-used part of the bandwidth on the network 19 is still adequate for including the fifth connection, the establishment of the new call is inhibited by the gatekeeper 15 based on the determination that the maximum number of connections permitted for the gateway 12 is exceeded.

In addition, when the amount of the traffic in a particular route on the network is considerably varied and the bandwidth used by the connections in a predetermined route on the network is limited, it is desired that the call control function to limit the number of connections related to the predetermined route be performed. However, it is difficult for the communication system in FIG. 1 to provide efficient utilization of the channels for the predetermined route on the network.

### SUMMARY OF THE INVENTION

An object of the present invention is to provide an improved communication system in which the above-described problems are eliminated.

Another object of the present invention is to provide a communication control apparatus that provides efficient utilization of the channels for a predetermined route on the IP network by performing a call control function suited to the current state of communications in the predetermined route, in order to carry out communications with high quality.

Another object of the present invention is to provide a communication control method that provides efficient utilization of the channels for a predetermined route on the IP network by performing a call control function suited to the current state of communications in the predetermined route on the IP network, in order to carry out communications with high quality.

The above-mentioned objects of the present invention are achieved by a communication control apparatus comprising: a call managing unit which detects a current state of communications in a predetermined route on an IP network; and a determination unit which determines, in response to a request for connecting a new call to the predetermined route, whether the request is accepted or rejected based on a result of comparison of the detected state of communications and a maximum amount of traffic of packets permitted for the predetermined route.

The above-mentioned objects of the present invention are achieved by a communication control method comprising the steps of: detecting a current state of communications in a predetermined route on an IP network; and determining, in response to a request for connecting a new call to the predetermined route, whether the request is accepted or rejected based on a result of comparison of the detected state of communications in the predetermined route and a maximum amount of traffic of packets permitted for the predetermined route.

The above-mentioned objects of the present invention are achieved by a communication system in which packets are transmitted over an IP network, the communication system including a gateway which connects a terminal on the gateway to the IP network, a gatekeeper which maps a phone number of the terminal into an IP address on the IP network, and a communication control apparatus, the communication control apparatus comprising: a call managing unit which detects a current state of communications in a predetermined route on the IP network; and a determination unit determining, in response to a request for connecting a new call to the predetermined route, whether the request is accepted or rejected based on a result of comparison of the detected state of communications and a maximum amount of traffic of packets permitted for the predetermined route.

In the communication control apparatus and method of the present invention, the call control function suited to the current state of communications in the predetermined route on the IP network can be carried out. The communication control apparatus and method of the present invention are effective in providing efficient utilization of the channels for the predetermined route on the IP network. It is possible that the communication system including the communication control apparatus carries out communications with high quality.

### BRIEF DESCRIPTION OF THE DRAWINGS

Other objects, features and advantages of the present invention will become apparent from the following detailed description when read in conjunction with the accompanying drawings.

FIG. 1 is a block diagram of a conventional communication system using the VoIP technology.

FIG. 2 is a block diagram of a communication system in which one preferred embodiment of the communication control apparatus of the invention is incorporated.

FIG. 3 is a block diagram of the software of a server in the communication system in FIG. 2.

FIG. 4 is a block diagram of the hardware of each of respective components of the communication system in FIG. 2.

FIG. 5 is a diagram for explaining a channel table managed by the server.

FIG. 6 is a diagram for explaining a call managing table managed by the server.

FIG. 7 is a block diagram of the software of a gatekeeper in the communication system in FIG. 2.

FIG. 8 is a diagram for explaining a correspondence table of phone numbers and IP addresses managed by the gatekeeper.

FIG. 9 is a block diagram of the software of a gateway in the communication system in FIG. 2.

FIG. 10 is a block diagram of the software of a router in the communication system in FIG. 2.

FIG. 11 is a diagram for explaining the format of a packet exchanged between the gatekeeper and the server.

FIG. 12 is a diagram for explaining a sequence of communications performed by the communication system in FIG. 2.

FIG. 13 is a diagram for explaining another sequence of communications performed by the communication system in FIG. 2.

FIG. 14 is a flowchart for explaining operation of the server in FIG. 3.

FIG. 15 is a flowchart for explaining operation of the server in FIG. 3.

### DETAILED DESCRIPTION OF PREFERRED EMBODIMENTS

A description will now be given of preferred embodiments of the present invention with reference to the accompanying drawings.

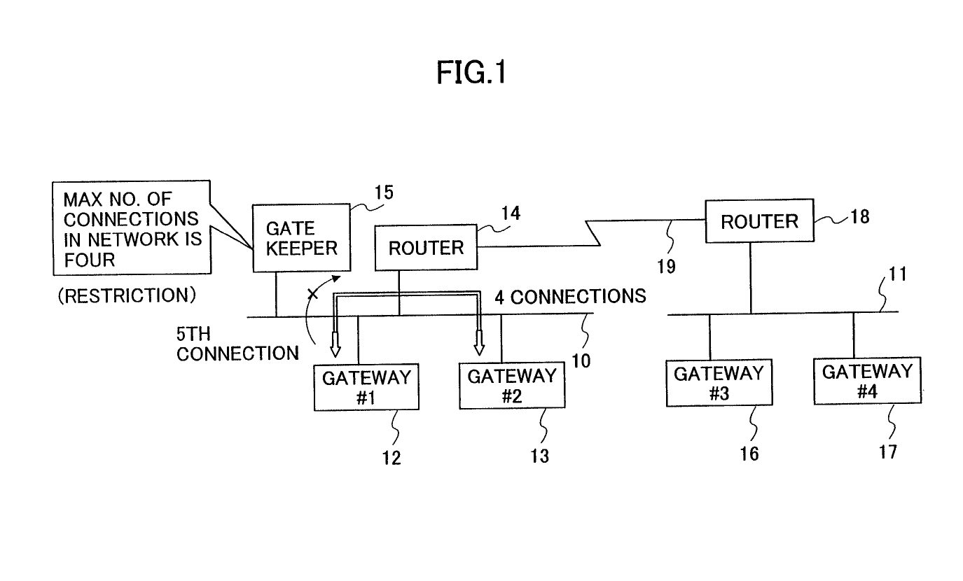

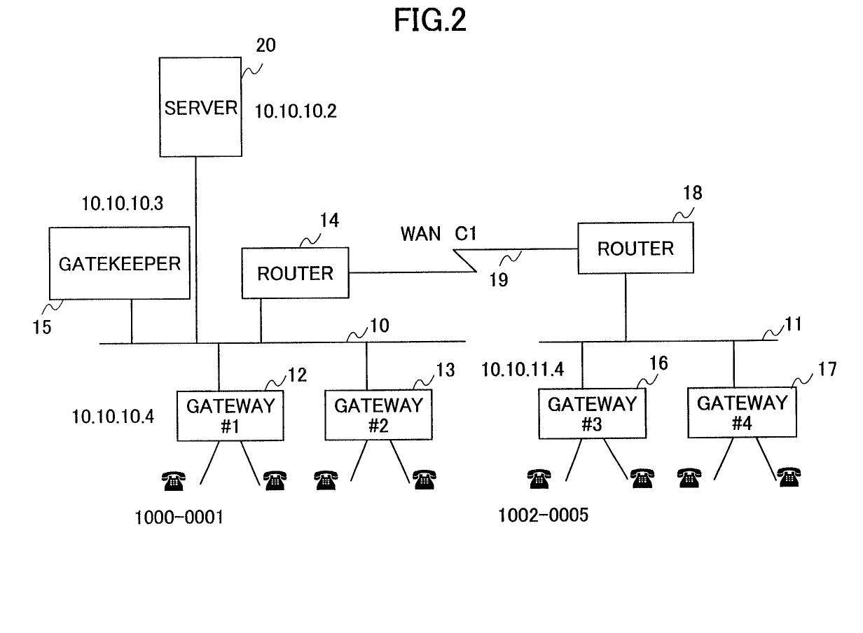

FIG. 2 shows a communication system in which one preferred embodiment of the communication control apparatus of the invention is incorporated. In FIG. 2, the elements that are essentially the same as corresponding elements in FIG. 1 are designated by the same reference numerals, and a description thereof will be omitted.

In the communication system in FIG. 2, one preferred embodiment of the communication control apparatus of the invention is incorporated into a server 20. In the present embodiment, the server 20 is connected onto the LAN 10. The present invention is not limited to this embodiment. Alternatively, the server 20 may be connected onto the LAN 11 or another network within the communication system, instead of the LAN 10.

The server 20 in the present embodiment detects a current state of communications in a predetermined route on the IP network. When a call setup request for setting up a new call related to the predetermined route is received, the server 20 determines whether the call setup request is accepted or rejected, based on a result of comparison of the detected current state of communications in the predetermined route and a maximum amount of traffic of packets permitted for the predetermined route.

In this regard, the predetermined route is selected from a portion of the IP network where the call control function is needed to limit the number of connections therein. For example, the predetermined route is selected from a portion of the network where it is expected that the amount of the traffic is considerably varied and the bandwidth used by the connections therein is limited. In the case of the communication system in FIG. 2, the transmitting route on the network 19 between the LAN 10 and the LAN 11 is selected as the predetermined route. Hereinafter, the predetermined route in the communication system in FIG. 2 is referred to as “WAN C1”.

When a call setup request from one of the gateways 12, 13, 16 and 17 is received, the server 20 determines whether the call indicated by the request is routed to pass through the predetermined route “WAN C1”. When the call is routed to pass through the predetermined route “WAN C1”, the server 20 determines whether the number of current connections in the predetermined route “WAN C1” when the new connection is added thereto exceeds the maximum number of connections permitted for the predetermined route “WAN C1”. Only when it is determined that the maximum number is not exceeded, the server 20 accepts the call setup request to establish the new connection in the predetermined route “WAN C1”.

As described above, the server 20 in the present embodiment performs the call control function suited to the current state of communications in the predetermined route on the IP network. Namely, it determines whether a call setup request is acceptable by the comparison of the current state of communications and the maximum number of connections permitted for the predetermined route in the communication system. Therefore, the communication control apparatus and method of the present embodiment provides efficient utilization of the channels for the predetermined route on the network. It is possible that the communication control apparatus and method of the present embodiment carry out communications with high quality.

Next, a description will be given of the structure and operation of the respective elements of the communication system of the present embodiment.

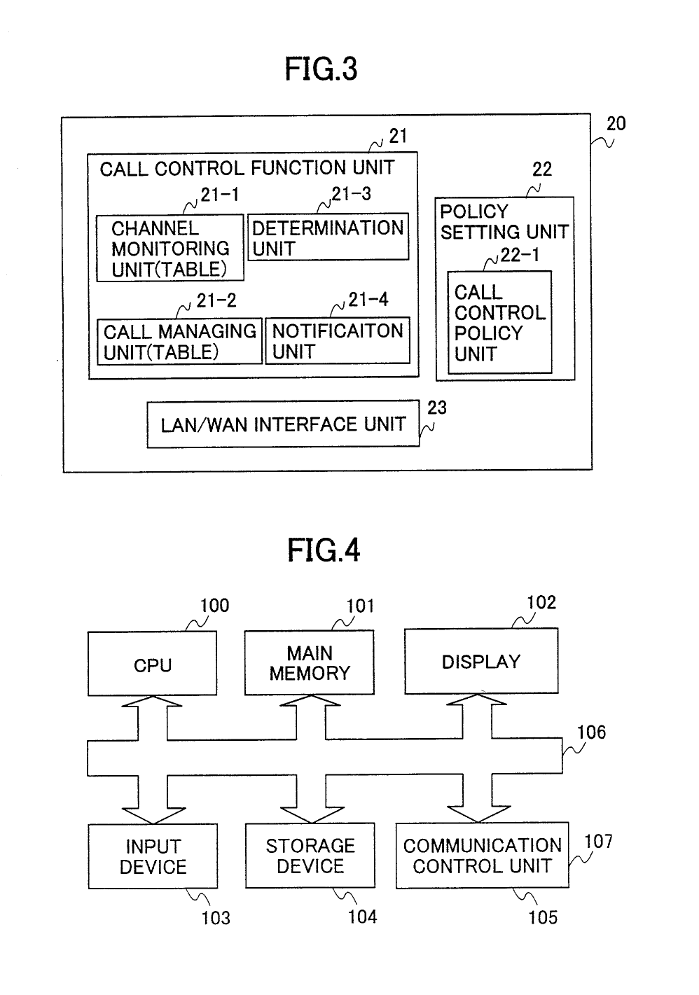

FIG. 3 shows the software of the server 20 in the communication system in FIG. 2. FIG. 4 shows the hardware of each of the respective components of the communication system in FIG. 2.

As shown in FIG. 4, the hardware of the server 20 generally includes a CPU 100, a main memory 101, a display 102, an input device 103, a storage device 104, a communication control unit 105, a bus 106, and a communication line (or channel) 107. The software (or program) of the server 20 in FIG. 4 is expanded onto the memory 101, and the CPU 100 executes the program on the memory 101. The communication control unit 105 is connected to the network 10 (shown in FIG. 2) via the communication line 107.

As shown in FIG. 3, the software of the server 20 generally includes a call control function unit 21, a policy setting unit 22, and a LAN/WAN interface unit 23. The call control function unit 21 is configured to perform the above-described call control function of the server 20. The call control function unit 21 includes a channel monitoring unit 21-1, a call managing unit 21-2, a determination unit 21-3 and a notification unit 21-4. The channel monitoring unit 21-1 maintains a channel table that is used to identify each of the respective connections between two of the gateways 12, 13, 16 and 17 within the communication system in FIG. 2. As described earlier, the transmitting route “WAN C1” on the network 19 between the LAN 10 and the LAN 11 is selected as the predetermined route in the present embodiment.

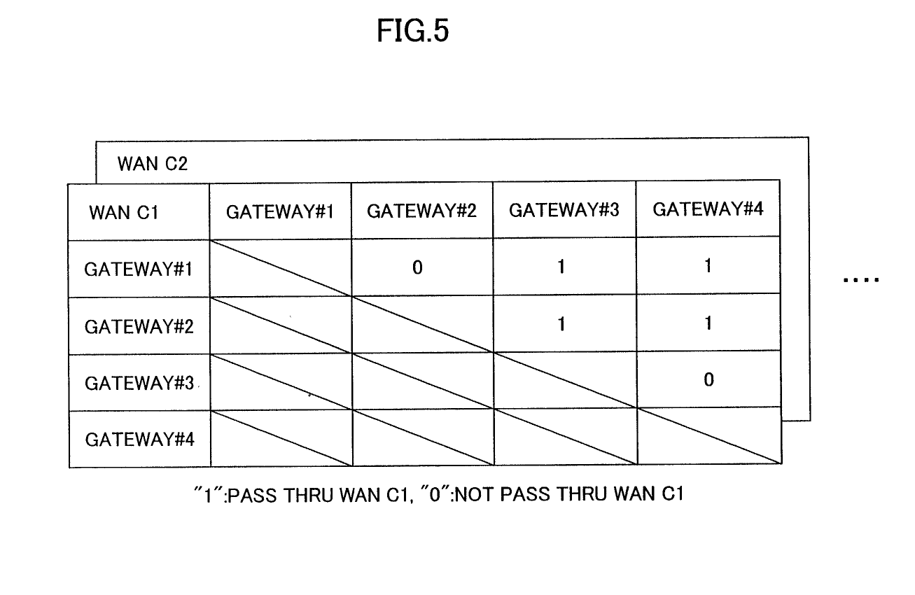

FIG. 5 shows a channel table that is managed by the channel monitoring unit 21-1 of the server 20. As shown in FIG. 5, in the channel table, each of the connections between two of the respective gateways (GATEWAY #1 through GATEWAY #4) within the system in FIG. 2 when performing the communication therebetween is identified. In the channel table in FIG. 5, the bit (which is called the channel information bit), which is allocated for each of the connections between two of the respective gateways, is set to one “1” when the connection is routed to pass through the predetermined route “WAN C1”, and it is set to zero “0” when the connection is routed not to pass through the predetermined route “WAN C1”. As is apparent from the channel table in FIG. 5, in the communication system in FIG. 2, there are four connections between two of the respective gateways 12, 13, 16 and 17 that are routed to pass through the predetermined route “WAN C1”.

In a case wherein a different transmitting route “WAN C2” on the network 19 between the LAN 10 and the LAN 11 is selected as the predetermined route, an additional channel table for the route “WAN C2, which is similar to the channel table in FIG. 5, may be also provided.

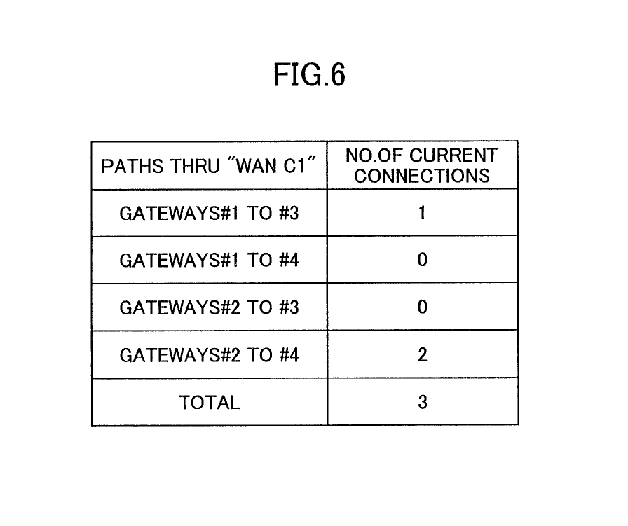

Referring back to FIG. 3, the call managing unit 21-2 of the server 20 updates and maintains a call managing table. An example of the call managing table is shown in FIG. 6. The call managing table is used to indicate the number of current connections between two of the respective gateways, the connections being routed to pass through the predetermined route “WAN C1” (the channel information bit being set to “1” in the channel table in FIG. 5).

The example of the call managing table in FIG. 6 indicates that: the number of current connections between GATEWAY #1 and GATEWAY #3 is one; the number of current connections between GATEWAY #2 and GATEWAY #4 is two; and the total number of current connections between the respective gateways on the predetermined route “WAN C1” is equal to three. When a new connection is established on the predetermined route “WAN C1” or when one of the current connections is released, the call managing unit 21-2 of the server 20 updates the contents of the call managing table based on the information received from the gatekeeper 15.

Referring back to FIG. 3, the determination unit 21-3 of the server 20 determines whether the establishment of a new connection on the predetermined route is possible, based on the information (the call managing table and the channel table) received from the call managing unit 21-2 and the channel monitoring unit 21-1, as well as the information (the maximum number of connections permitted for the predetermined route) received from the policy setting unit 22. The notification unit 21-4 transmits a notification, indicating a result of the determination produced by the determination unit 21-3, to the gatekeeper 15. The notification unit 21-4 performs the transmission of this notification at the time either an inquiry sent by the gatekeeper 15 or a change of the maximum number of connections made by the policy setting unit 22 is received at the notification unit 21-4.

Further, in the software of the server 20 in FIG. 3, the policy setting unit 22 includes a call control policy unit 22-1 that sets or changes the maximum number of connections permitted for the predetermined route, based on the input call control policy which is input to the server 20 by a human network administrator using the input device 103 (for example, a keyboard). The LAN/WAN interface unit 23 controls the communication control unit 105 based on the standard communication protocols, so that the transmission and receiving of packets between the server 20 and the LAN 10 or the WAN 19 is controlled.

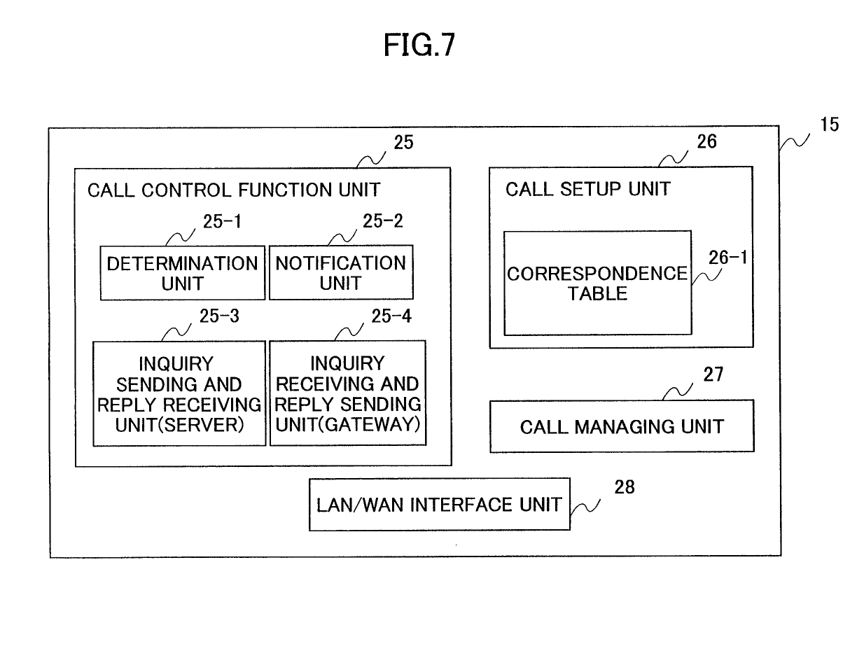

FIG. 7 shows the software of the gatekeeper 15 in the communication system in FIG. 2. The hardware of the gatekeeper 15 is essentially the same as the hardware of the server 20 shown in FIG. 4, and a description thereof will be omitted.

As shown in FIG. 7, the software of the gatekeeper 15 generally includes a call control function unit 25, a call setup unit 26, a call managing unit 27, and a LAN/WAN interface unit 28. The call control function unit 25 is configured to perform the call control function of the gatekeeper 15. The call control function unit 25 includes a determination unit 25-1, a notification unit 25-2, an inquiry-sending and reply-receiving unit 25-3, and an inquiry-receiving and reply-sending unit 25-4.

As described earlier, in the conventional communication system, the gatekeeper 15 determines whether the establishment of a new connection on the predetermined route is possible or not. The gatekeeper 15 in the conventional communication system functions to limit the number of connections allocated to each of the gateways served by the gatekeeper 15. However, in the present embodiment, the predetermined route is the route “WAN C1” on the network 19 between the router 14 and the router 18, and the determination unit 25-1 of the gatekeeper 15 in the present embodiment need not perform the call control function that is the same as that performed by the server 20. Namely, the determination unit 21-3 of the server 20 determines whether the establishment of a new connection on the predetermined route is possible or not. Hence, the determination unit 25-1 of the present embodiment merely receives the result of the determination from the server 20 via the inquiry-sending and reply-receiving unit 25-3, and sends it to the notification unit 25-2.

In the software of the gatekeeper 15 of the present embodiment, the notification unit 25-2 receives a call setup request from a certain gateway via the inquiry-receiving and reply-sending unit 25-4, and transmits a reply, which is created based on the result of the determination (the call control function) received from the determination unit 25-1, back to the gateway.

Further, in the software of the gatekeeper 15 of the present embodiment, the inquiry-sending and reply-receiving unit 25-3 exchanges information with the server 20. The inquiry-receiving and reply-sending unit 25-4 exchanges information with each of the gateways 12, 13, 16 and 17. These units 25-3 and 25-4 are configured such that the following function is achieved. Namely, when the call setup request sent by a certain gateway is received at the server 20 and the server 20 determines that the establishment of the new connection is possible, the gatekeeper 15 maps a phone number of a calling telephone on the gateway into an IP address on the network 19 (WAN), and sends the IP address to the gateway. On the other hand, when it is determined that the establishment of the new connection is not possible, the gatekeeper 15 sends a busy tone to the source telephone via the sender gateway.

Further, in the software of the gatekeeper 15 in FIG. 7, the call setup unit 26 includes a correspondence table 26-1 of phone numbers and IP addresses. When a call setup request for connecting a new call to the predetermined route “WAN C1” is transmitted from a calling telephone on a certain gateway to the server 20, the call setup unit 26 controls the call setup operation such that it selects a corresponding one of the entries (the IP addresses) in the correspondence table 26-1 and sends the corresponding IP address to the gateway.

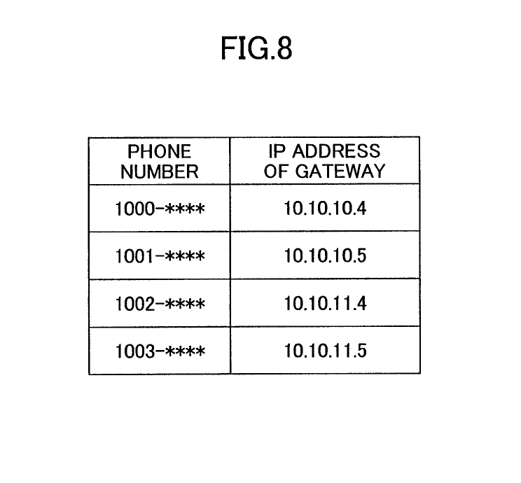

FIG. 8 shows a correspondence table 26-1 of phone numbers and IP addresses, which is managed by the call setup unit 26 of the gatekeeper 15. With respect to the communication system of the present embodiment, examples of IP addresses of some of the system components (e.g., the gateways 12 and 16, the gatekeeper 15 and the server 20) and examples of phone numbers of some telephones on the gateways 12 and 16 within the system are indicated as shown in FIG. 2. According to the correspondence table in FIG. 8, for example, the phone number “1000-0001” of the telephone on the gateway 12 (GATEWAY #1) is mapped into the IP address “10.10.10.4” of the gateway 12 (GATEWAY #1).

Further, in the software of the gatekeeper 15 in FIG. 7, the call managing unit 27 monitors the number of current connections between two related ones of the respective gateways 12, 13, 16 and 17 in the predetermined route “WAN C1” on the network 12. The call managing unit 27 of the gatekeeper 15 sends the number of current connections to the call managing unit 21-2 of the server 20 over the network 10, so that a corresponding item of the call managing table (FIG. 6) is updated by the call managing unit 21-2 in accordance with the received number of current connections. The LAN/WAN interface unit 28 controls the communication control unit 105 (FIG. 4) of the gatekeeper 15 based on the standard communication protocols, so that the transmission and receiving of packets between the gatekeeper 15 and the LAN 10 (or the LAN 11) or the WAN 19 is controlled.

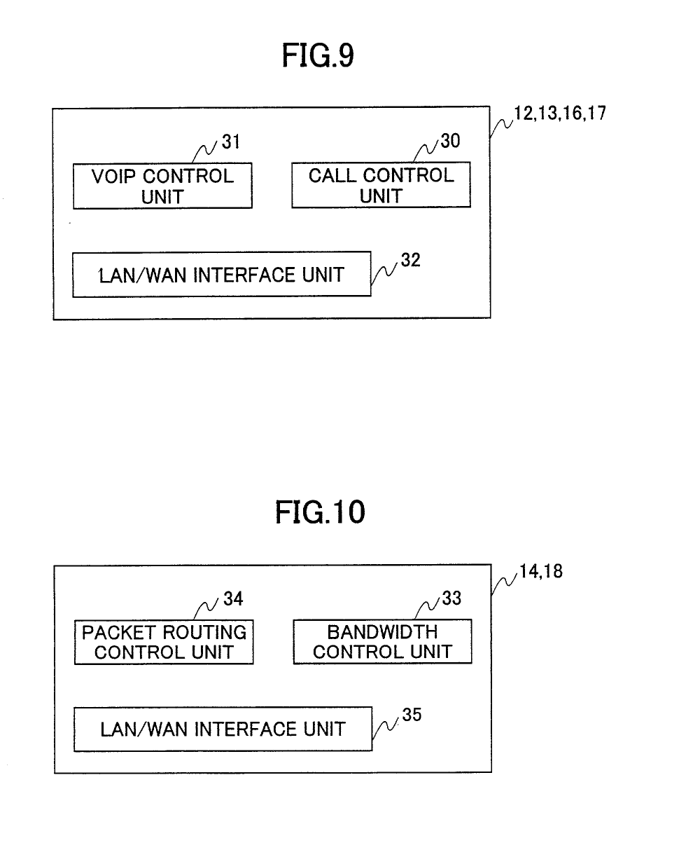

FIG. 9 shows the software of each of the gateways 12, 13, 16 and 17 in the communication system in FIG. 2. The hardware of each gateway is essentially the same as the hardware of the server 20 shown in FIG. 4, and a description thereof will be omitted.

As shown in FIG. 9, the software of each of the gateways 12, 13, 16 and 17 (which will be called the gateway) generally includes a call control unit 30, a VoIP control unit 31, and a LAN/WAN interface unit 32. The call control unit 30 transmits a call setup request to the gatekeeper 15 over the network 10 (or 11) when such request for connecting a new call to the predetermined route “WAN C1” is originated by a calling telephone on the gateway. The VoIP control unit 31 performs the VoIP control of the gateway (e.g., encoding or decoding of a voice signal, and encapsulating or decapsulating of a voice signal). The LAN/WAN interface unit 32 controls the communication control unit 105 (FIG. 4) of the gateway based on the standard communication protocols, so that the transmission and receiving of packets between the gateway and the LAN 10 (or the LAN 11) or the WAN 19 is controlled.

FIG. 10 shows the software of each of the routers 14 and 18 in the communication system in FIG. 2. The hardware of each router is essentially the same as the hardware of the server 20 shown in FIG. 4 except that the router is not provided with the storage device 104.

As shown in FIG. 10, the software of each of the routers 14 and 18 (which will be called the router) generally includes a bandwidth control unit 33, a packet routing control unit 34, and a LAN/WAN interface unit 35. The packet routing control unit 34 performs the routing of packets. The bandwidth control unit 33 controls the transmission of specific-type packets (e.g., VoIP packets) over the network 10, 11 or 19 while ensuring that adequate bandwidth is provided for the transmission. This control is performed such that the traffic of packets of other types than the VoIP type does not considerably affect the transmission of VoIP packets. The bandwidth control unit 33 is capable of performing the setting of the bandwidth by receiving from the server 20 an amount of the bandwidth adequate for the transmission of VoIP packets. The LAN/WAN interface unit 35 controls the communication control unit 105 (FIG. 4) of the router based on the standard communication protocols, so that the transmission and receiving of packets between the router and the LAN 10 (or the LAN 11) or the WAN 19 is controlled.

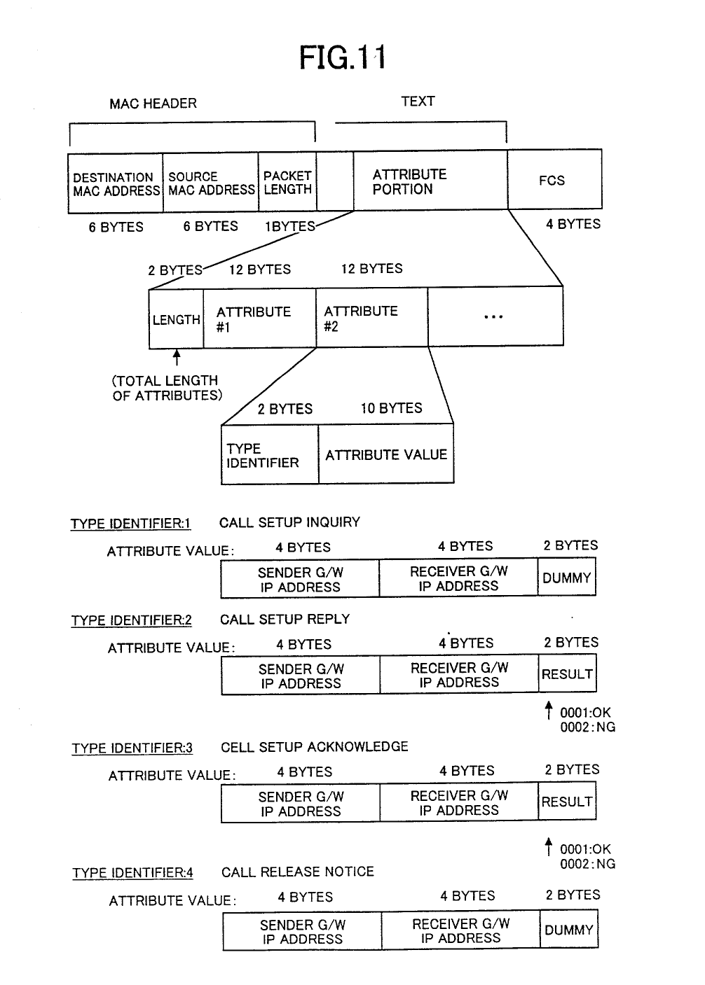

FIG. 11 shows the format of a packet exchanged between the gatekeeper 15 and the server 20.

As indicated in the upper portion of FIG. 11, the packet is comprised of a MAC header, a text section and an FCS (Frame Check Sequence). The MAC header is divided into a destination MAC address (6 bytes), a source MAC address (6 bytes), and a packet length (1 byte). The text section includes an attribute portion that is divided into an attribute length (2 bytes) and a set of attributes (each with 12 bytes). The attribute length indicates a total length of the attribute portion. Each attribute includes a type identifier (2 bytes) and an attribute value (10 bytes). The type identifier indicates a specific type of message included in the attribute.

As indicated in the lower portion of FIG. 11, there are four types of message that are included in the attributes of the packet exchanged between the gatekeeper 15 and the server 20 in the communication system of the present embodiment. When the type identifier is set to “1”, the type of message of the attribute is the call setup inquiry. When the type identifier is set to “2”, the type of message of the attribute is the call setup reply. When the type identifier is set to “3”, the type of message of the attribute is the call setup acknowledge. When the type identifier is set to “4”, the type of message of the attribute is the call release notice. The attribute value of each attribute includes an IP address of the sender gateway (4 bytes), an IP address of the receiver gateway (4 bytes), and dummy bytes (2 bytes). The dummy bytes included in the attribute value are used to indicate supplementary information for each of the message types: the call setup inquiry and the call setup acknowledge, which will be described below.

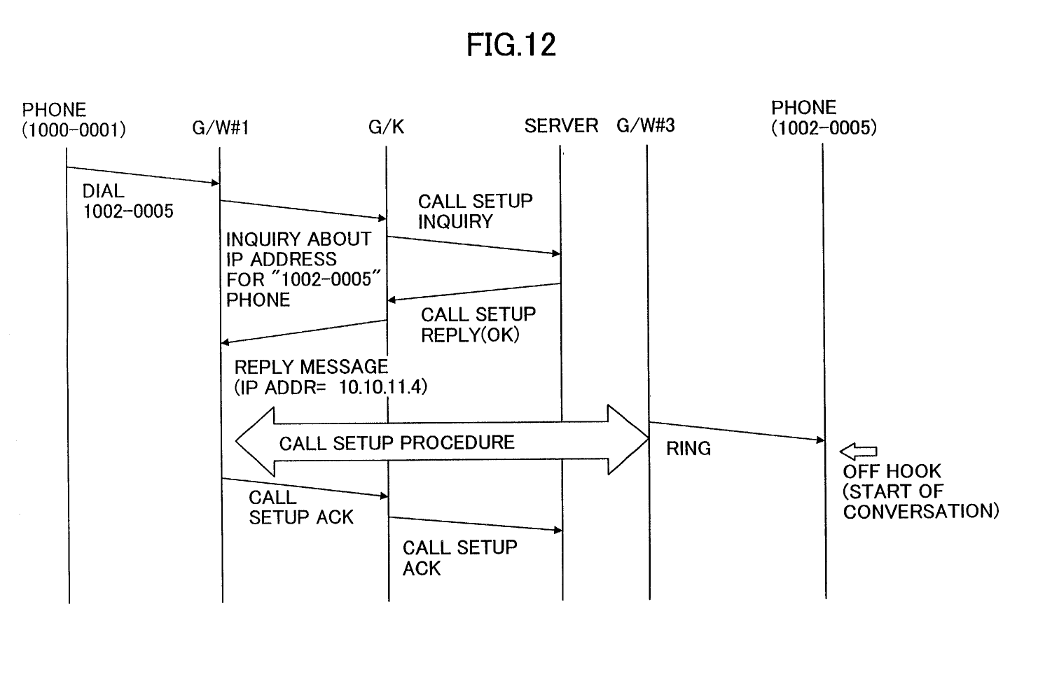

Next, a description will be given of operation of the communication system of the present embodiment in FIG. 2, including operation of the server 20, with reference to FIG. 12 through FIG. 15.

In the following, it is supposed that the maximum number of connections permitted for the predetermined route “WAN C1” is set at four. As described earlier, the setting of the maximum number of connections is performed by the call control policy unit 22-1 of the policy setting unit 22, based on the input call control policy which is input by the human network administrator using the input device 103.

The initial conditions of the communication system are as follows. The channel monitoring unit 21-1 of the server 20 maintains the channel table (FIG. 5), and, in the channel table, each of the connections between two of the respective gateways 12, 13, 16 and 17 is identified and the channel information bit for each connection indicates whether the connection is routed to pass through the predetermined route “WAN C1”. The call managing unit 21-2 of the server 20 maintains the call managing table (FIG. 6). In the initial conditions, there is no connections in the predetermined route “WAN C1”, and the numbers of current connections related to all the paths between two of the respective gateways are reset to zero. The IP address of the server 20 is “10.10.10.2” as shown in FIG. 2.

The call setup unit 26 of the gatekeeper 15 creates the correspondence table of phone numbers and IP addresses as shown in FIG. 8. The creation of the correspondence table may be performed in accordance with manual operations. Alternatively, the call setup unit 26 of the gatekeeper 15 may automatically create the correspondence table by receiving from each gateway the related information containing the IP address of the gateway and the phone numbers of the telephones on the gateway. In the latter case, each gateway transmits the packets including the related information to the gatekeeper 15.

In the initial conditions, there is no connection on the network 10, and the call managing unit 27 of the gatekeeper 15 has no call entry. The IP address of the gatekeeper 15 is “10.10.10.3” as shown in FIG. 2.

At each of the gateways 12, 13, 16 and 17, the VoIP control unit 31 maintains the phone numbers of the telephones that are connected onto the gateway related. The IP address of the gateway 12 (GATEWAY #1) is “10.10.10.4” and the IP address of the gateway 16 (GATEWAY #3) is “10.10.11.4” as shown in FIG. 2.

FIG. 12 shows a sequence of communications performed by the communication system in FIG. 2.

In the sequence of communications in FIG. 12, suppose that the telephone (the phone number: 1000-0001) on the gateway 12 (G/W #1) dials “1002-0005” which is the phone number of the telephone on the gateway 16 (G/W #3), and a call setup process to establish a new connection between these telephones is done successfully. The indications of the routers 14 and 18 are omitted in the sequence in FIG. 12 since the routers 14 and 18 perform merely the routing operations.

In the sequence in FIG. 12, when the calling telephone dials “1002-0005”, the sender gateway 12 (G/W #1) sends a call setup request for connecting a new call to the predetermined route WAN C1, to the gatekeeper 15, in order to receive the IP address of the receiver gateway 16 (G/W #3). When the call setup request from the gateway 12 is received at the gatekeeper 15, the gatekeeper 15 creates a call setup inquiry by accessing the correspondence table 26-1 (FIG. 8), and sends the call setup inquiry to the server 20. This call setup inquiry is in the format of the type identifier=1 shown in FIG. 11. The dummy bytes (the last two bytes of the call setup inquiry) contain information used to identify the call setup inquiry. In the present example, the IP address of the sender gateway (the first four bytes of the call setup inquiry) is “10.10.10.4”, and the IP address of the receiver gateway (the middle four bytes of the call setup inquiry) is “10.10.11.4”.

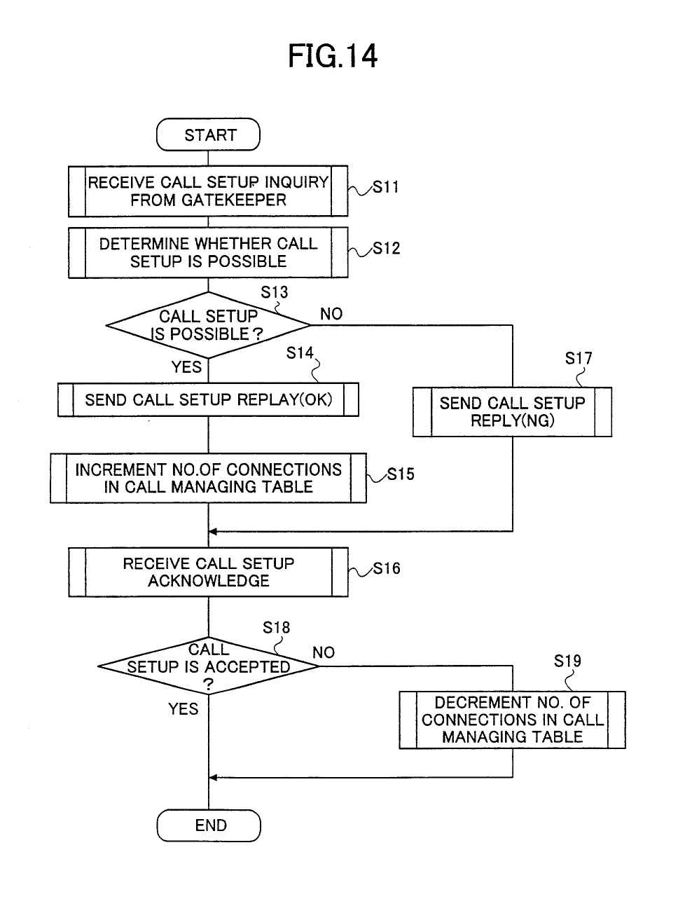

FIG. 14 shows a call control process that is performed by the server 20 in FIG. 3. The call control process performed by the server 20 will now be described with reference to FIG. 14.

As shown in FIG. 14, the server 20 receives the call setup inquiry from the gatekeeper 15 (S11). Then the server 20 (the determination unit 21-3) determines whether the establishment of a new connection onto the predetermined route “WAN C1” is possible, by accessing the channel table (the channel monitoring unit 21-1) and the call managing table (the call managing unit 21-2) (S12, S13). As described above, the determination unit 21-3 determines whether the number of current connections on the predetermined route “WAN C1” is less than the maximum number of connections (in the present example, 4) permitted for the predetermined route “WAN C1”.

When the communication system is in the initial conditions, the number of current connections is equal to 0 and the result of the determination at step S13 is affirmative. In the example of the call managing table in FIG. 6, the number of current connections is equal to 3 and the result of the determination at step S13 is affirmative. In this case, the server 20 (the notification unit 21-4) creates a call setup reply (OK) and sends it to the sender gateway 12 (G/W #1) (S14). This call setup reply is in the format of the type identifier=2 shown in FIG. 11. When the call setup is possible, “0001” is written to the dummy bytes (the last two bytes of the call setup reply).

After the step S14 is performed, the server 20 (the call managing unit 21-2) increments the number of current connections with respect to a corresponding one of the paths (passing through the predetermined route “WAN C1”) for the path of concern in the call managing table (S15). In the present example, the number of current connections with respect to the path between the gateway 12 and the gateway 16 (GATEWAY #1 to GATEWAY #3) in the call managing table is incremented at the step S15.

As indicated in the sequence in FIG. 12, when the call setup reply (OK) from the server 20 is received at the gatekeeper 15 (G/K), the gatekeeper 15 sends a reply message, including the IP address of the receiver gateway (in the present example, the IP address “10.10.11.4” of G/W #3), to the sender gateway 12 (G/W #1).

On the other hand, the receiver gateway 16 (G/W #3) sends a ring signal to the destination telephone on the gateway 16 whose phone number is “1002-0005”, as shown in sequence in FIG. 12. If the destination telephone is set in the off-hook state, then the conversation between the source telephone (“1000-0001”) and the destination telephone (“1002-0005”) starts in accordance with the standard call setup procedure. After this, the sender gateway 12 (G/W #1) sends a call setup acknowledge (OK) to the server 20 via the gatekeeper 15 (G/K). This call setup acknowledge is in the format of type identifier=3 shown in FIG. 11. The IP address of the receiver gateway in the call setup acknowledge is set to “10.10.11.4”, which indicates the IP address of the gateway 16 (G/W #3). When the call setup is accepted, “0001” is written to the dummy bytes (the last two bytes of the call setup acknowledge).

As shown in FIG. 14, after the step S15 is performed, the server 20 receives the call setup acknowledge from the gatekeeper 15 (S16). When the call setup acknowledge from the gatekeeper 15 is received, the server 20 determines whether the dummy bytes of the received setup acknowledge are set to “0001” (S18). Namely, it is determined at the step S18 whether the call setup is accepted or rejected. When the dummy bytes of the received setup acknowledge are set to “0001”, the server 20 determines that the call setup is accepted, and therefore the call control process of FIG. 14 ends. On the other hand, when the dummy bytes of the received setup acknowledge are set to “0002”, the server 20 determines that the call setup is rejected, which will be described later.

After the conversation between the source telephone and the destination telephone ends, the gateway 12 (G/W #1) sends a message, indicating the end of conversation, to the gatekeeper 15 (G/K). This is omitted in the sequence in FIG. 12. The gatekeeper 15 (G/K) sends a call release notice to the server 20. This call release notice is in the format of type identifier=4 shown in FIG. 11. The dummy bytes of the call release notice contains information used to identify the call release notice.

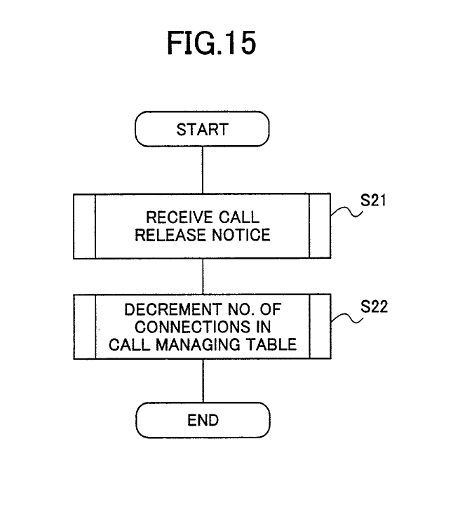

FIG. 15 shows a call control process that is performed by the server 20 in this case. As shown in FIG. 15, the server 20 receives the call release notice from the gatekeeper 15 (S21). After the step S21 is performed, the server 20 decrements the number of current connections with respect to a corresponding one of the paths (passing through the predetermined route “WAN C1”) for the path of concern in the call managing table (S22). In the present example, the number of current connections with respect to the path between the gateway 12 and the gateway 16 (GATEWAY #1 to GATEWAY #3) in the call managing table is decremented at the step S22. After the step S22 is performed, the call control process of FIG. 15 ends.

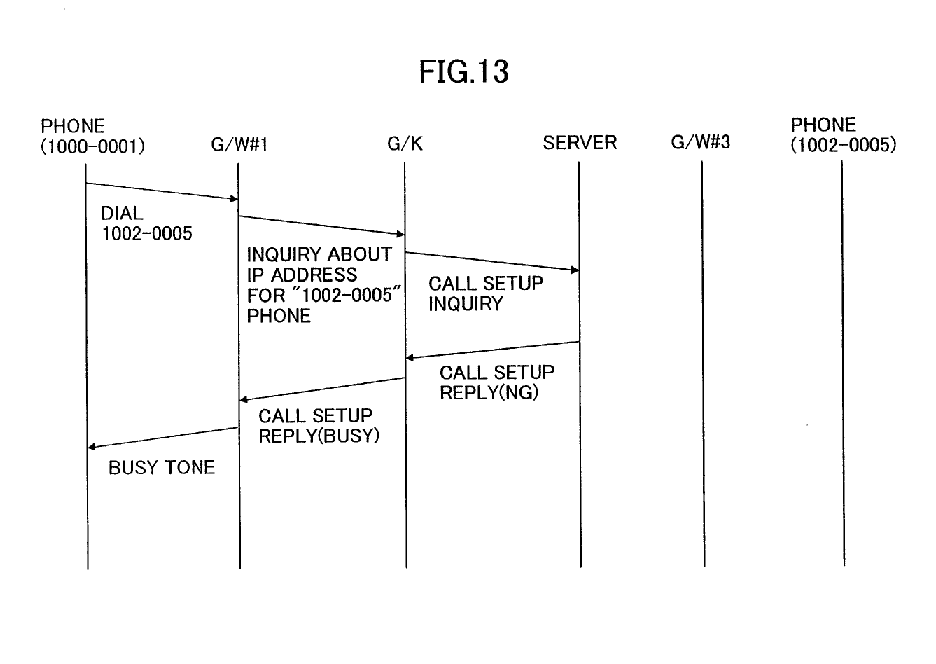

Next, FIG. 13 shows another sequence of communications performed by the communication system in FIG. 2.

In the sequence of communications in FIG. 13, it is supposed that the source telephone (the phone number: 1000-0001) on the gateway 12 (G/W #1) dials “1002-0005” which is the phone number of the destination telephone on the gateway 16 (G/W #3), but a call setup process to establish a new connection between these telephones is failed because the destination telephone is in the busy state.

In the sequence in FIG. 13, when the calling telephone dials “1002-0005”, the sender gateway 12 (GIW #1) sends a call setup request for connecting a new call to the predetermined route WAN C1, to the gatekeeper 15, in order to receive the IP address of the receiver gateway 16 (G/W #3). When the call setup request from the gateway 12 is received at the gatekeeper 15, the gatekeeper 15 creates a call setup inquiry by accessing the correspondence table 26-1 (FIG. 8), and sends the call setup inquiry to the server 20. The dummy bytes (the last two bytes of the call setup inquiry) contain information used to identify the call setup inquiry.

In the sequence in FIG. 13, the destination telephone on the gateway 16 (G/W #3) is in the busy state, and the server 20 (the notification unit 21-4) creates a call setup reply (NG) and sends it to the sender gateway 12 (G/W #1). This call setup reply is in the format of the type identifier=2 shown in FIG. 11. As the call setup is not possible, “0002” is written to the dummy bytes (the last two bytes of the call setup reply). When the call setup reply (NG) from the server 20 is received, the gatekeeper 15 (G/K) sends a busy tone to the source telephone via the sender gateway 12 (G/W #1).

Next, a description will be given of the call control process performed by the communication system of the present embodiment in a case in which the establishment of a new connection related to the predetermined route is not possible since the number of current connections on the predetermined route exceeds the maximum number of connections permitted for the predetermined route.

In the above-described case, the server 20 performs the steps S11 to S13 of the call control process (FIG. 14) in the same manner as in the case of the sequence in FIG. 12. The server 20 at the step S13 determines that the number of current connections on the predetermined route “WAN C1” exceeds the maximum number of connections (in the present example, 4) permitted for the predetermined route “WAN C1”. Namely, the result at the step S13 is negative.

As shown in FIG. 14, when the result at the step S13 is negative, the server 20 (the notification unit 21-4) creates a call setup reply (NG) and sends it to the sender gateway 12 (G/W #1) (S17). This call setup reply is in the format of the type identifier=2 shown in FIG. 11. As the call setup is not possible, “0002” is written to the dummy bytes (the last two bytes of the call setup reply).

When the call setup reply (NG) from the server 20 is received, the gatekeeper 15 (G/K) sends a busy tone to the source telephone (1000-0001) via the sender gateway 12 (G/W #1). Further, the sender gateway 12 (G/W #1) sends a call setup acknowledge (NG) indicating the failure of the call setup, to the server 20 via the gatekeeper 15 (G/K). This call setup acknowledge is in the format of type identifier=3 shown in FIG. 11. When the call setup is rejected, “0002” is written to the dummy bytes (the last two bytes of the call setup acknowledge).

As shown in FIG. 14, after the step S17 is performed, the server 20 receives the call setup acknowledge (NG) from the gatekeeper 15 (S16). When the call setup acknowledge from the gatekeeper 15 is received, the server 20 determines whether the dummy bytes of the received setup acknowledge are set to “0001” (S18). Namely, it is determined at the step S18 whether the call setup is accepted or rejected. When the dummy bytes of the received setup acknowledge are set to “0002”, the server 20 determines that the call setup is rejected. In this case, the result at the step S18 is negative, and the server 20 decrements the number of current connections with respect to a corresponding one of the paths (passing through the predetermined route “WAN C1”) for the path of concern in the call managing table (Sl9). In the present example, the number of current connections with respect to the path between the gateway 12 and the gateway 16 (GATEWAY #1 to GATEWAY #3) in the call managing table is decremented at the step S19. After the step S19 is performed, the call control process of FIG. 14 ends.

As described above, the communication system of the present embodiment can carry out the call control function suited to the current state of communications in the predetermined route on the IP network, which has been difficult for the conventional communication system to carry out. The communication control apparatus and method of the present invention are effective in providing efficient utilization of the channels for the predetermined route on the IP network. It is possible that the communication system including the communication control apparatus carries out communications with high quality.

The present invention is not limited to the above-described embodiment, and variations and modifications may be made without departing from the scope of the present invention. For example, the call managing unit 21-1 of the server 20 in the above-described embodiment detects the number of current connections in the predetermined route WAN C1 on the IP network. Alternatively, the call managing unit 21-1 of the server 20 may detect a current amount of bandwidth allocated for the route WAN C1. In such alternative embodiment, assuming that a maximum amount of bandwidth permitted for the route WAN C1 is, for example, 50 Mbps, the call managing table in FIG. 6, which is provided for managing the number of current connections for each path, is modified into a bandwidth managing table for managing the current amount of bandwidth allocated for each path. The total amount of bandwidth allocated for the route WAN C1 is managed and compared to the maximum amount of bandwidth permitted for the route WAN C1.

Further, in the alternative embodiment, the gatekeeper is capable of detecting the amount of bandwidth required to connect a new call to the route WAN C1. Information indicating the amount of the required bandwidth is written to the dummy bytes of the call setup inquiry. The determination unit 21-3 of the server 20 determines whether the establishment of a new connection on the route WAN C1 is possible, based on the bandwidth managing table (indicating the current amounts of bandwidth allocated for the related paths) and the channel table as well as the maximum amount of bandwidth permitted for the route WAN C1. When the total of the current amounts of bandwidth allocated is less than the maximum amount of bandwidth permitted, it is determined that the establishment of a new connection on the route WAN C1 is possible. The setting and changing of the maximum amount of bandwidth permitted is performed by the router 14 or the router 18.

In the above-described embodiment, the gatekeeper 15 and the server 20 are separate components in the communication system. However, it is possible that a single integrated component including both the functions of the gatekeeper 15 and the server 20 be provided instead. Alternatively, a signal integrated component including all the functions of the gatekeeper 15, the server 20 and the router 14 may be provided.

Further, the above-described embodiment is related to the voice transmission over the IP network. However, the present invention is not limited to this embodiment, and it is also applicable to real-time voice and data transmission over the IP network without departing from the scope of the present invention.

Further, the present invention is based on Japanese priority application No. 2000-402066, filed on Dec. 28, 2000, the entire contents of which are hereby incorporated by reference.

What is claimed is:

1. A communication control apparatus comprising:
a call managing unit detecting a current state of communications in a predetermined route on an IP network; and
a determination unit determining, in response to a request for connecting a new call to the predetermined route, whether the request is accepted or rejected based on a result of comparison of the detected state of communications and a maximum amount of traffic of packets permitted for the predetermined route.

2. The communication control apparatus according to claim 1, wherein the current state of communications, detected by the call managing unit, is either the number of current connections in the predetermined route or a bandwidth allocated for the predetermined route.

3. A communication control method comprising the steps of:
detecting a current state of communications in a predetermined route on an IP network; and
determining, in response to a request for connecting a new call to the predetermined route, whether the request is accepted or rejected based on a result of comparison of the detected state of communications in the predetermined route and a maximum amount of traffic of packets permitted for the predetermined route.

4. A communication system in which packets are transmitted over an IP network, the communication system including a gateway which connects a terminal on the gateway to the IP network, a gatekeeper which maps a phone number of the terminal into an IP address on the IP network, and a communication control apparatus,
the communication control apparatus comprising:
a call managing unit detecting a current state of communications in a predetermined route on the IP network; and
a determination unit determining, in response to a request for connecting a new call to the predetermined route, whether the request is accepted or rejected based on a result of comparison of the detected state of communications and a maximum amount of traffic of packets permitted for the predetermined route.

5. The communication system according to claim 4, wherein the call managing unit and the determination unit of the communication control apparatus have a function to communicate with the gatekeeper.
